(19) United States
(12) Patent Application Publication
(10) Pub. No.: US 2011/0182499 A1
(43) Pub. Date: Jul. 28, 2011

(54) METHOD FOR DETERMINING THE SURFACE COVERAGE OBTAINED BY SHOT PEENING

(75) Inventors: Goetz G. FELDMANN, Oberursel (DE); Wolfgang HENNIG, Simmern (DE)

(73) Assignee: ROLLS-ROYCE DEUTSCHLAND LTD & CO KG, Blankenfelde-Mahlow (DE)

(21) Appl. No.: 13/009,188

(22) Filed: Jan. 19, 2011

(30) Foreign Application Priority Data
Jan. 27, 2010 (DE) 10 2010 001 286.6

(51) Int. Cl. G06K 9/00

(52) U.S. Cl. 382/154

(57) ABSTRACT

In a method for determining the surface coverage obtained by shot peening to ensure uniform and complete strengthening of the surface of components, in particular blisk blades, a shot-peened surface topography is digitalized by an optical digital recording unit. A three-dimensional height profile is then prepared by measuring and evaluation software which includes both indentations and excrescences due to shot peening and also roughnesses due to manufacturing, which are smaller than the excrescences and indentations. The roughnesses are subsequently filtered out from the height image by a software filter using mathematical methods. A height diagram with the indentations situated below a zero line is established, with the size of these indentations being calculated in relation to the total area in the height diagram and the extent of coverage of the entire shot-peened surface being determined therefrom.

This application claims priority to German Patent Application DE102010001286.6 filed Jan. 27, 2010, the entirety of which is incorporated by reference herein.

This invention relates to a method for determining the surface coverage obtained by shot peening in order to strengthen the surface of components, in particular blisk blades.

Shot peening is a process in which the surface of a workpiece is bombarded with spherical media at high velocity. Here, compressive residual stresses are imparted to the surface of the workpiece by which the surface is strengthened and, consequently, susceptibility to cracking reduced. An important assessment criterion for the effectiveness of shot peening and the quality of surface strengthening is surface coverage, or coverage of the component during shot peening, i.e. the ratio between the surface hit by the shot particles and the surface to be processed. Coverage, as complete as possible, on the one hand, enables the properties of the component to be optimally improved. On the other hand, overpeening of the workpiece surface may result in damage to the component. As is generally known, the extent of coverage is inspected visually, actually by examining the shot-peened surface with a magnifying glass for deformed and non-deformed areas or by coating the surface to be peened with a fluorescent film and viewing under ultraviolet light after peening to determine visually dark (peened) and bright (non-peened) areas. Visual examination is complicated by different processing states during component manufacture (turning, milling, grinding, etching) and varying parameters during the shot-peening strengthening process (hardness, size, impingement angle, shot pressure, workpiece hardness) and requires a high degree of expertise. Visual inspection is therefore strongly subjective and carries the inaccuracies involved therewith. Further disadvantages are difficult reproducibility and limited documentability of the extent of coverage.

In a broad aspect, the present invention provides a method for determining shot-peening coverage by way of which precise, reproducible and documentable determination of the extent of coverage of shot-peened surfaces is ensured.

In a method for determining the surface coverage obtained by shot peening to ensure strengthening of the surface of components, in particular blisk blades, as uniform and complete as possible, the present invention, in essence, provides that the surface topography of a certain reference surface of a shot-peened component is digitalized by an optical digital recording unit and a three-dimensional height image (height profile) is prepared by a measuring and evaluation software which includes the indentations and excrescences due to shot peening as well as the roughnesses due to manufacturing, which are smaller than the excrescences and indentations. The manufacturing-due roughnesses are subsequently filtered out from the height image by a software filter using mathematical methods and a height diagram with the indentations situated below a zero line is established, with the size of these indentations being calculated in relation to the non-indented areas of the height diagram and the extent of coverage of the entire shot-peened surface being determined therefrom. The method enables the shot-peening indentations to be exactly localized, allowing the extent of coverage obtained in the shot-peening process to be exactly determined, independently of subjective influences. On the basis of such precise measuring results, the shot-peening strengthening process can be performed time and cost-effectively, in high quality and without overpeening.

In development of the method according to the present invention, the reference surface is selected visually and features a shot-peening coverage of max. 50%.

In a further development of the present invention, a confocal microscope or a white-light interferometer is used as digital recording unit.

In a further development of the present invention, the manufacturing state-dependent software filter is designed for different component materials and/or different shot-peening media.

The present invention is more fully described in light of the accompanying drawings, showing a preferred embodiment. In the drawings,

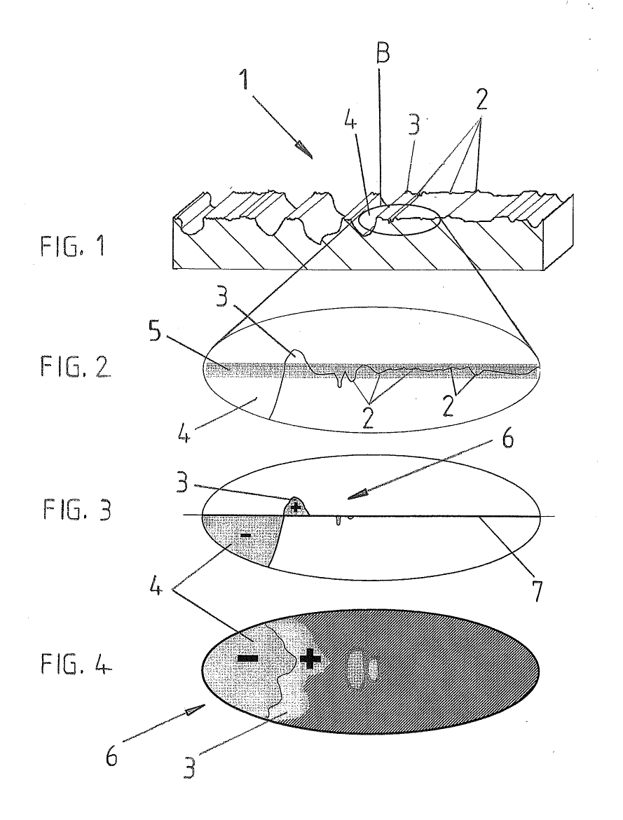

FIG. 1 is a highly enlarged sectional view of a surface zone to be evaluated (three-dimensional height image) of a shot-peened workpiece,

FIG. 2 shows the extension of the surface profile in a section B of the shot-peened surface area with a compensation plane covering the roughnesses,

FIG. 3 is a sectional representation of the surface structure in section B without roughnesses (height diagram), and

FIG. 4 is a top view as per FIG. 3.

Firstly, a certain—shot-peened—reference surface with a visually established coverage of max. 50% is selected and the height profile of the respective surface section digitalized in that the respective position of each point of the surface topography is determined by an optical digital recording unit (3D scanner), for example, a confocal microscope or a white-light interferometer. Subsequently, a three-dimensional height image 1 is prepared by a measuring and evaluation software (FIG. 1).

In the subsequent step, manufacturing-due surface roughnesses 2 (e.g. scores) specific to the respective processing state, such as milling, turning, etching, grinding or the like, which are smaller than the excrescences 3 (elevations) and indentations 4 (depressions) due to shot peening, are filtered out by a software filter (processing state-dependent filter) using mathematical methods. The software filter also takes account of the different component materials, for example titanium, steel or nickel-base alloys, as well as the shape, size and material peculiar to the various shot-peening media. FIG. 2 shows the filtering out of the manufacturing-due roughnesses (heights and depths) together with the compensation plane 5.

Upon filtering out the roughnesses, the—filtered—height diagram 6 (without manufacturing-due roughnesses) as per FIG. 3 containing solely the peening-due excrescences 3 and indentations 4 situated above and beneath a determined zero line 7 is provided, which is also shown in FIG. 4 in top view. Thus, the shot impacts (indentations 4 with the respective excrescences 3) are exactly localized in relation to other roughnesses.

In the following step, the size of the areas of the indentations 4 lying beneath the zero plane is calculated and related to the total area, thereby exactly determining the shot-peened area or the coverage (extent of surface coverage by shot-peening), respectively. On the basis of such precise measuring results, shot peening is controllable such that complete coverage of the workpiece surface and, thus, optimum strengthening of the surface of the respective component is obtained without overpeening. In addition, shot peening can be performed time and cost-effectively and in high quality.

### LIST OF REFERENCE NUMERALS

1 Three-dimensional height image
2 Roughnesses due to manufacturing
3 Excrescence due to shot peening
4 Indentation due to shot peening
5 Compensation plane
6 Height diagram of excrescences and indentations
7 Zero line

What is claimed is:

1. A method for determining a surface coverage obtained by shot peening done to strengthen the surface of a component, comprising:
digitalizing a surface topography of a certain reference surface of a shot-peened component with an optical digital recording unit;
preparing a three-dimensional height profile with a measuring and evaluation software, the height profile including indentations and excrescences due to shot peening as well as roughnesses due to manufacturing, which roughnesses are smaller than the excrescences and indentations;
filtering out the roughnesses due to manufacturing from the height image with a software filter using mathematical methods;
establishing a height diagram of the surface with the indentations situated below a zero line;
calculating a size of the indentations in relation to a total area in the height diagram and from that, determining an extent of coverage of shot-peening over the surface.

2. The method of claim 1, wherein the reference surface includes a shot-peening coverage of 50% maximum and is selected visually.

3. The method of claim 2, and further comprising using at least one of a confocal microscope and a white-light interferometer as the digital recording unit.

4. The method of claim 3, wherein the software filter is state-dependent to take into account at least one of different component materials, different component conditions and different shot-peening media.

5. The method of claim 4, wherein the software filter is state-dependent to take into account each of different component materials, different component conditions and different shot-peening media.

6. The method of claim 5, wherein the component is a blisk blade.

7. The method of claim 1, and further comprising using at least one of a confocal microscope and a white-light interferometer as the digital recording unit.

8. The method of claim 7, wherein the software filter is state-dependent to take into account at least one of different component materials, different component conditions and different shot-peening media.

9. The method of claim 8, wherein the software filter is state-dependent to take into account each of different component materials, different component conditions and different shot-peening media.

10. The method of claim 9, wherein the component is a blisk blade.

11. The method of claim 1, wherein the software filter is state-dependent to take into account at least one of different component materials, different component conditions and different shot-peening media.

12. The method of claim 11, wherein the software filter is state-dependent to take into account each of different component materials, different component conditions and different shot-peening media.

13. The method of claim 12, wherein the component is a blisk blade.

14. The method of claim 1, wherein the component is a blisk blade.

15. The method of claim 2, wherein the software filter is state-dependent to take into account at least one of different component materials, different component conditions and different shot-peening media.

16. The method of claim 15, wherein the software filter is state-dependent to take into account each of different component materials, different component conditions and different shot-peening media.

17. The method of claim 16, wherein the component is a blisk blade.
